(19) United States
(12) Patent Application Publication
(10) Pub. No.: US 2003/0128548 A1
(43) Pub. Date: Jul. 10, 2003

(54) License plate lamp

(75) Inventor: Roy W. Bowen, Kokomo, IN (US)

Correspondence Address: Brian T. Ster, ICE MILLIER, One American Square, Box 82001, Indianapolis, IN, 46282-0002, US

(73) Assignee: Guide Corporation, Pendleton, IN

(21) Appl. No.: 10/037,273

(22) Filed: Jan. 4, 2002

(51) Int. Cl. B60Q 1/56

(52) U.S. Cl. 362/497; 362/548; 362/800

(57) ABSTRACT

A license plate lamp utilizing an integrally molded component comprising a base portion, a hollow lens portion, and a light source holder. The light source holder of the molded component is adapted to hold an electrical connector and a light source within the hollow lens portion. The electrical connector provides electrical connection between the light source and the electrical system of the vehicle. The molded component is molded with means to mount the disclosed license lamp to the exterior surface of a vehicle in a manner which allows access to the interior of the disclosed license lamp from inside the trunk of the vehicle.

### BACKGROUND OF INVENTION

Local and national governmental regulations require automotive vehicles operating on intrastate or interstate roadways to have valid license plates. Additional laws and regulations require the license plates to be clearly visible to law enforcement officials from certain locations relative to the vehicle. A problem arose however, in that the license plates were not visible when vehicles were driven after sunset or during inclement weather without illumination. To address this problem, automotive license plate lamps (“license lamps”) were developed. A license lamp comprises: a housing, a lens, and a light source connected to a vehicular power source. The license lamp is installed on a vehicle adjacent to the vehicle's license plate. Generally, each license lamp is designed and installed on a vehicle such that it is activated when the vehicle's headlamps are activated.

Although well known and widely used in the art, the license lamps described above are expensive to produce and difficult to assemble. The difficulty is a result of the separate housing and lens components required of license lamps known in the art. Each of the components in such prior art license lamps has unique manufacturing costs and considerations. For example, the housing and lens must be separately molded, and the separate components must be attached prior to installing a license lamp onto a vehicle. This “attaching” step also adds cost to manufacturing a license lamp, due to the additional labor and materials generally required to snap, weld, glue or otherwise attach the lens and housing together. Thus, a need exists for a functional license lamp that is less expensive and less difficult to manufacture and service.

### BRIEF SUMMARY OF THE INVENTION

The present invention provides for a license plate lamp that minimizes the number of individual components, increasing manufacturing efficiency and decreasing costs. The disclosed license lamp utilizes an integrally molded component comprising a base portion, a hollow lens portion, and a light source holder. The light source holder of the molded component is adapted to hold an electrical connector and a light source within the hollow lens portion. The electrical connector, which may be a commercially available lamp socket, provides electrical connection between the light source and the electrical system of the vehicle.

The molded component of the present invention also is molded with means to mount the disclosed license lamp to the exterior surface of the vehicle. This exterior surface contains an opening into the trunk of the vehicle. The molded component of the present invention is then mounted on the vehicle in a manner which allows access to the interior of the disclosed license lamp from inside of the trunk of the vehicle. Manufacturing efficiency and cost savings are attained by molding a license lamp which eliminates the need for a separate housing.

### BRIEF DESCRIPTION OF THE DRAWINGS

FIG. 1 is a top cross-sectional view of a first exemplary embodiment of a license lamp in accordance with the present invention;

FIG. 2 is a perspective exploded view of the embodiment of the license lamp of FIG. 1 wherein the components of the license lamp have been separated;

FIG. 3 is side cross-sectional view of the embodiment of the license lamp of FIG. 1;

FIG. 4 is a rear view of the license lamp of FIG. 1;

FIG. 5 is a front view of an aperture in the retaining flange of the license lamp of FIG. 1;

FIG. 6 is a perspective view of a gasket of the type used with the present invention;

FIG. 7 is a side cross-sectional view of a second exemplary embodiment of a license lamp in accordance with the present invention;

FIG. 8 is a side view of the license lamp of FIG. 7;

FIG. 9 is a top view of the license lamp of FIG. 7; and

FIG. 10 is a rear view of the license lamp of FIG. 7.

### DETAILED DESCRIPTION OF THE INVENTION

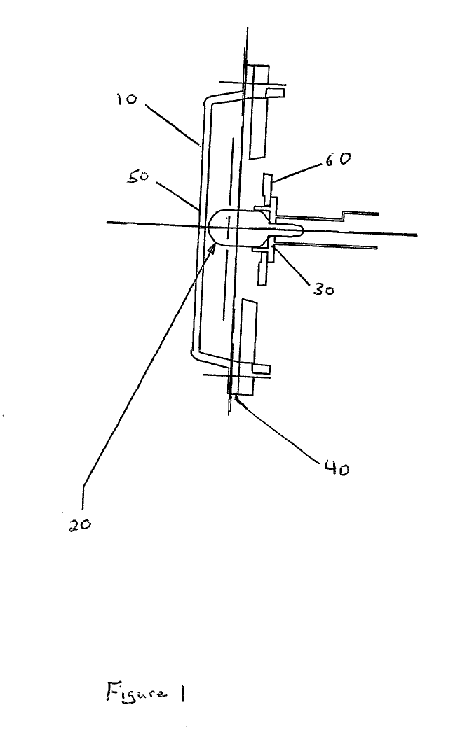

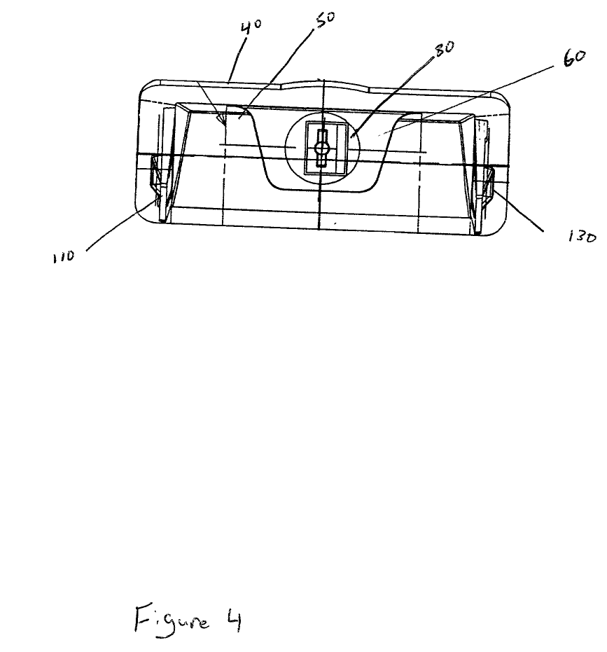

FIGS. 1-5 illustrate one of the exemplary embodiments of the present invention. As depicted in FIGS. 1-5, this embodiment of the present invention comprises single housing and lens component 10 which is of unitary molded construction, light source 20, and electrical connector 30. As the figures illustrate, housing and lens component 10 is molded so that it has a flat base portion 40, a hollow trapezoidal lens portion 50 extending outwardly from base portion 40, and a retaining flange 60 extending inwardly from base portion 40. The entire license lamp assembly is mounted over an opening in the exterior surface of the vehicle (not shown).

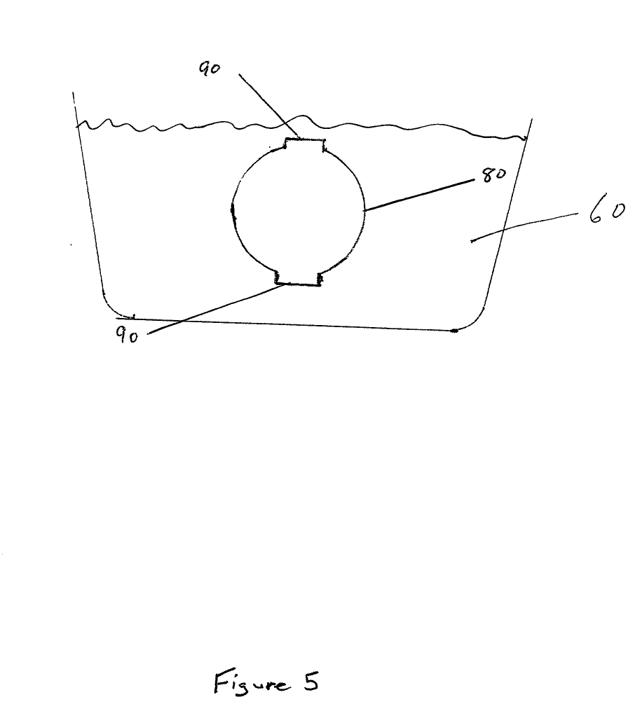

Electrical connector 30 is a socket into which light source 20 can be inserted and electrically connected. Electrical connector 30 also comprises one or more rectangular locking tabs (not shown) to secure itself into place using a bayonet-type twist-lock configuration as described below and means to electrically connect a vehicle's electrical power source (not shown) to light source 20. Electrical connector 30 can be any of a number of conventional bulb sockets utilizing a twist-lock configuration of the type described below. As shown in FIG. 5, retaining flange 60 contains substantially circular aperture 80 which includes one or more circumferentially spaced rectangular cutouts 90. Circular aperture 80 has a diameter roughly equal to that of electrical connector 30. The exact size of circular aperture 80 may be varied to accept various conventional bulb sockets known in the art. FIG. 5 depicts the shape of circular aperture 80 with two rectangular cutouts 90 which are dimensioned to receive the locking tabs (not shown) on connector 30. The tabs hold connector 30 on flange 60 when connector 30 is rotated.

During assembly, light source 20 is inserted into and electrically connected to electrical connector 30. Light source 20 and electrical connector 30 are then inserted into circular aperture 80 of retaining flange 60. Once the locking tabs of electrical connector 30 are guided through cutouts 90 of circular aperture 80 in retaining flange 60, electrical connector 30 is turned so that the locking tabs frictionally interfere with retaining flange 60, locking electrical connector 30 and light source 20 into their proper position in the license lamp. One skilled in the art will appreciate that the present invention could utilize a number of different electric light sources, including, for example, a light emitting diode (LED) or a small light bulb. Electrical connector 30 will necessarily vary depending on the light source utilized.

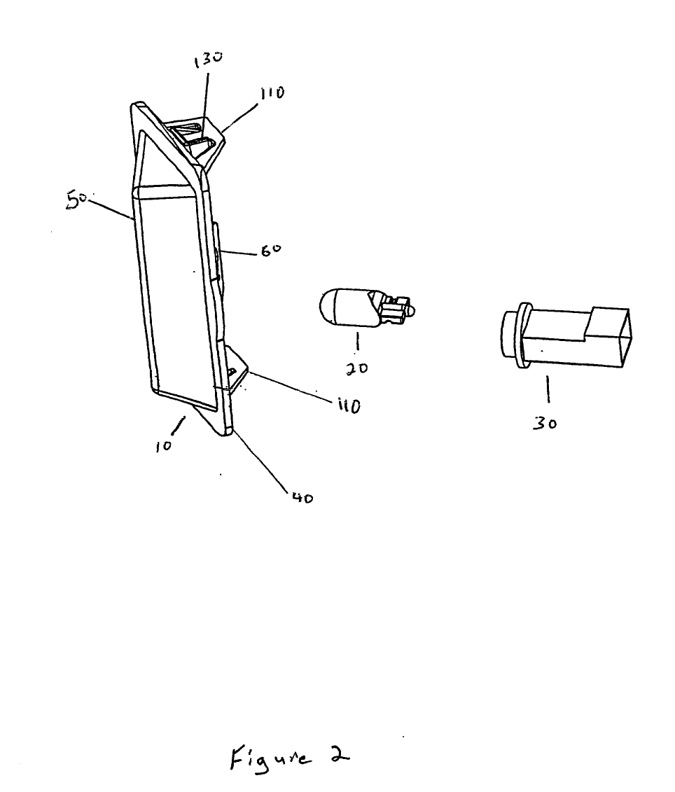

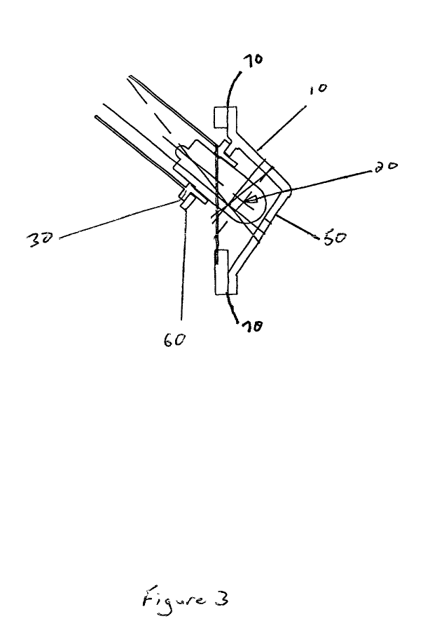

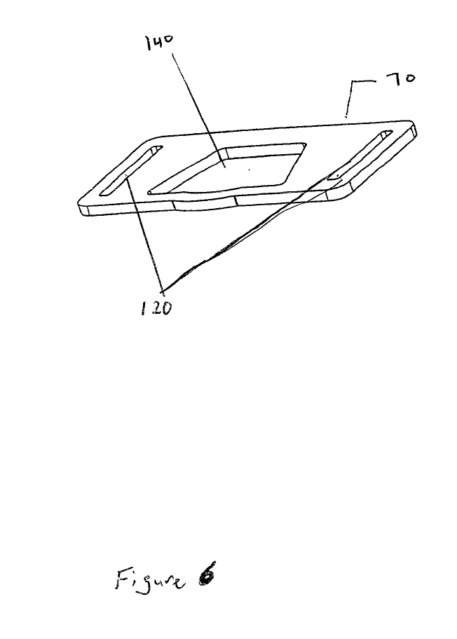

To assure a weather tight seal between housing and lens component 10 and the exterior surface of the vehicle, a gasket 70 is seated along flat base portion 40 prior to the assembly's installation over the opening in the exterior surface of the vehicle. (See FIG. 3) As depicted in FIG. 2, tabs 110 are molded at each of the longitudinal ends of flat base portion 40 of housing and lens component 10. Tabs 110 project out from the bottom side of flat base portion 40 of housing and lens component 10. FIG. 6 shows an uninstalled gasket 70. Gasket 70 is configured with two slots 120 through which tabs 110 are inserted as gasket 70 is seated against flat base portion 40. Once gasket 70 is seated, tabs 110 are inserted into the opening in the exterior surface of the vehicle which is sized such that it is slightly smaller than gasket 70 to allow for the formation of a watertight seal. The sides of tabs 110 have flexible protruding wedge shape engaging means 130 which must flex to allow tabs 110 to be slid into the opening. As tabs 110 are inserted into the opening, gasket 70 is compressed between flat base portion 40 and the exterior surface of the vehicle. Once tabs 110 are fully inserted, engaging means 130 “snap” back into place and secure housing and lens component 10 to the vehicle. Gasket 70 has an opening 140 which aligns with aperture 80 in retaining flange 60 when the license lamp is mounted on the vehicle. The alignment of opening 140 and retaining flange 60 allows a failed light source in the present license lamp to be replaced from inside the trunk of the vehicle.

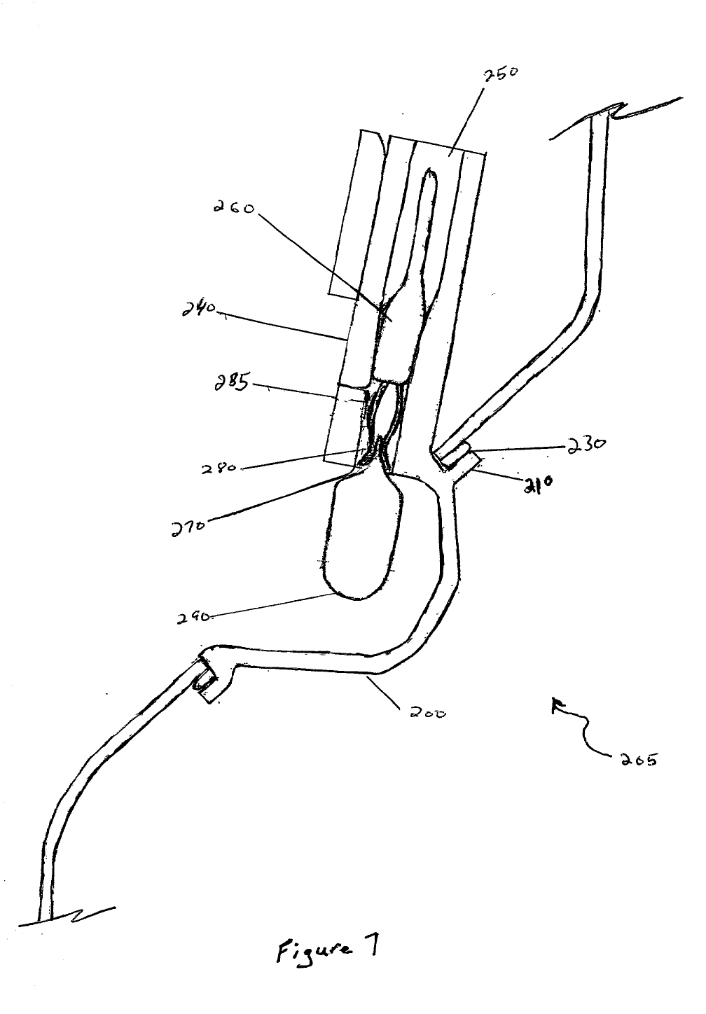

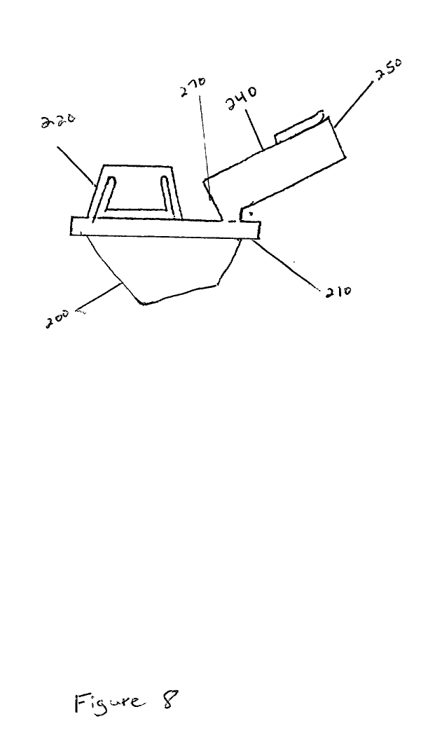

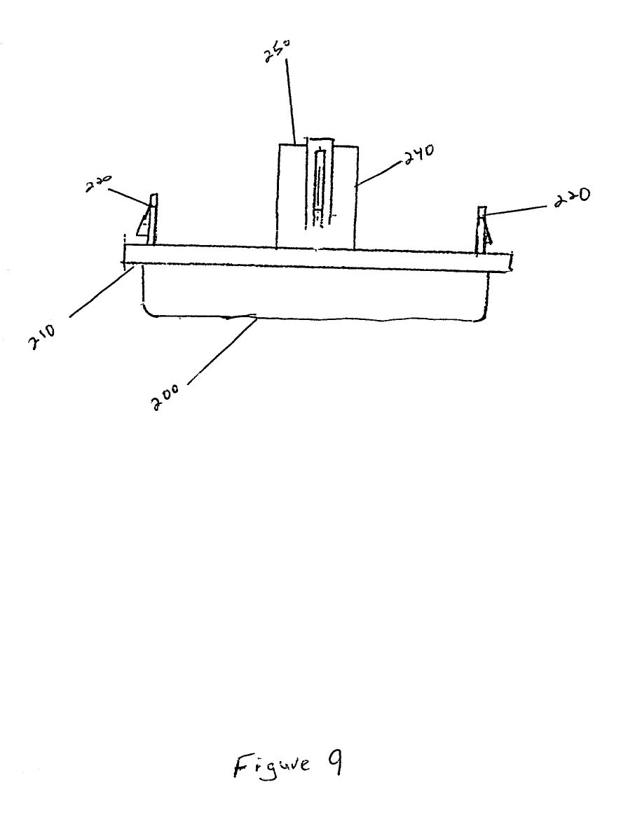

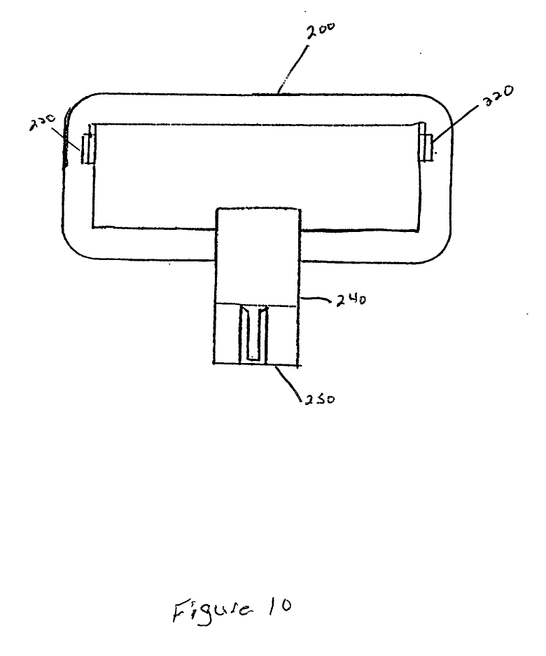

FIGS. 7-10 depict another embodiment of the present invention. As depicted, this embodiment of the present invention, assembly 205, employs single molded piece 200. Single molded piece 200 is molded such that it consolidates a lens, a housing, and a bulb holder all into a single molded piece of plastic 200. Single molded piece 200 is substantially similar to single housing and lens component 10 described above. Like the previous embodiment, single molded piece 200 has a flat base portion 210 with similarly placed tabs 220 extending therefrom. Gasket 230, which is substantially similar to gasket 70 is seated along flat base portion 210 and, like in the previous embodiment, provides a weather tight seal between single molded piece 200 and the exterior of the vehicle when the components are assembled in the same manner as those of the first embodiment.

A hollow tube 240 is integrally molded to single molded piece 200 and projects at an angle from the side of flat base portion 210. Hollow tube 240 has openings at each end and acts as a light source holder for single molded piece 200. The posterior open end 250 of hollow tube 240 is large enough to allow the insertion of an electrical connector 260. In some embodiments, the interior cavity of cylindrical tube 240 may gradually decrease in size between posterior open end 250 and anterior open end 270 to form a snug frictional fit around electrical connector 260. As shown in FIG. 7, terminals 280 extend from the end of electrical connector 260. Once in place, terminals 280 on electrical connector 260 extend to the anterior open end 270 of hollow tube 130. Angled retaining clip 285 extends from terminals 280 back toward hollow tube 130 and interferes with the edge of hollow tube to help secure electrical connector 260 in place. Light source 290 may then be inserted between terminals 280 to electrically connect the light source to electrical connector 260.

As in the previous embodiment, light source 290 could be one of many different light sources known in the art. Electrical connector 260 can be any electrical connector known in the art compatible with light source 290. As such, the exact shape and size of the light source holder portion of single molded piece 200 may vary. As in the earlier described embodiment, access to light source 290 after assembly is complete is available from the trunk of the vehicle through the opening in the exterior surface of the vehicle. Light source 290 may be replaced through this access point.

The single piece design of the present invention is easier and more efficient to manufacture than those of the prior art. The prior art requires the following three steps, among others, to produce a license lamp: (1) fabricating a housing; (2) fabricating a lens; and (3) attaching the housing and lens together. These additional manufacturing steps cause the process (whether manual or automatic) to produce fewer units of product over a given time and for a greater amount of money expended in running the process. All embodiments of the present invention, however, have a single housing and lens component. Thus, only one piece, rather than two, must be fabricated to form the lens and housing. Additionally, no “attaching” of the housing and lens is required. Thus, the present invention can be more efficiently produced than the prior art. Additionally, the single piece of the present invention integrates a light source holder which in the various embodiments may accept commercially available lamp bulb sockets or other electrical connectors known in the art.

The single piece of the present invention is preferably made of plastic and formed by an injection molding process with three movable slides per cavity. The first described embodiment which uses retaining flange 60 instead of tube 240 to hold the electrical connector simplifies the molding process and is preferable. It should also be recognized that while the present embodiments are shown with retaining means comprising tabs 110 or 220 to secure the assembly over the opening in the exterior surface of the vehicle, any suitable retaining means could be used, such as conventional screws or any threaded, friction, or another interference type fastener.

Although the present invention has been described in considerable detail with reference to certain exemplary versions thereof, other versions are possible. Therefore, the spirit and scope of the appended claims should not be limited to the description of the exemplary versions contained herein, and the claims should be given the broadest possible interpretation to protect the novel features of the present invention.

What is claimed is:

1. A vehicular lamp assembly for illuminating a license plate mounted on a vehicle with a light source electrically connected to an electrical system of the vehicle, wherein the vehicle has an exterior surface with an opening formed there through adjacent a license plate, said assembly comprising:
a molded component comprising a base portion having an opening formed there through, a lens portion rigidly, integrally molded completely over said opening in said base portion and extending outwardly from said base portion to form a hollow interior portion of said lens portion accessible through said opening and a light source holder integrally molded to said base portion adjacent said opening;
an electrical connector, said electrical connector adapted to provide for electrical connection to the light source and electrical connection to the electrical system of the vehicle;
said light source holder adapted to hold said electrical connector so that when the light source is held by said electrical connector, the light source extends into said hollow portion of said lens portion; and
means for retaining said base portion to the exterior surface of the vehicle so that said opening through said base portion overlies the opening through the surface of the vehicle to allow access to the light source from the interior of the vehicle.

2. The vehicular lamp assembly of claim 1, wherein said light source holder comprises a molded hollow tube which holds said electrical connector.

3. The vehicular lamp assembly of claim 1, wherein said light source holder is molded with an opening there through, wherein said electrical connector employs a twist-lock mechanism, and wherein said opening through said light source holder is adapted to lockingly accept said electrical connector employing said twist-lock mechanism.

4. The vehicular lamp assembly of claim 1, wherein said means for retaining said base portion to the exterior surface of the vehicle comprises at least one locking tab extending from said base portion, said at least one locking tab configured to be inserted into the opening formed through the exterior surface.

5. The vehicular lamp assembly of claim 1, wherein said means for retaining said base portion to the exterior surface of the vehicle comprises at least one fastener connecting said base portion to the exterior surface of the vehicle.

6. The vehicular lamp assembly of claim 1, wherein said molded component is molded of thermoplastic.

7. The vehicular lamp assembly of claim 1, wherein a sealing gasket is provided between said base portion and the exterior surface of the vehicle to prevent the passage of moisture.

8. The vehicular lamp assembly of claim 1, wherein said light source holder comprises a hollow tubular structure having openings at each end, the hollow interior dimensioned to receive at one end and retain electrical connectors connected to the electrical system and adapted to electrically engage the light source when the light source is inserted in the other end.
